(19) United States
(12) Patent Application Publication
(10) Pub. No.: US 2016/0219153 A1
(43) Pub. Date: Jul. 28, 2016

(54) Method for Providing Personalized Voicemails

(71) Applicant: John Wiley Honea, Ft. Pierce, FL (US)

(72) Inventor: John Wiley Honea, Ft. Pierce, FL (US)

(21) Appl. No.: 14/972,818

(22) Filed: Dec. 17, 2015

Related U.S. Application Data
(60) Provisional application No. 62/106,447, filed on Jan. 22, 2015.

(51) Int. Cl. H04M 3/533; H04M 1/725; H04M 3/42; H04W 4/12

(52) U.S. Cl. CPC H04M 3/53391; H04W 4/12; H04M 1/7255; H04M 3/42059; H04M 1/72555

(57) ABSTRACT

A method for storing personalized voicemail messages for a plurality of stored contacts initially prompts the user to record a customized voicemail message for each of the plurality of stored contacts. When received, the customized voicemail message is assigned to at least one selected contact from the plurality of stored contacts. The customized voicemail message is played to a caller, if a telephone number of the caller matches with the telephone number associated with the at least one selected contact. In order to do so, the telephone number of the caller is compared with the telephone number of each of the plurality of stored contacts. The customized voicemail can contain a voice message and also a designated number of alert tones which are played before the voice message is heard.

The current application claims a priority to the U.S. Provisional Patent application Ser. No. 62/106,447 filed on Jan. 22, 2015.

### FIELD OF THE INVENTION

The present invention relates generally to a method of leaving personalized voicemails for each of the contacts on a contact list. More specifically, the method introduced in the present invention synchronizes and coordinates phone numbers on a contact list with an individual voice message for each specific contact.

### BACKGROUND OF THE INVENTION

Voicemail has turned out to be a vital part of an individual's daily routine due to its convenience. A voice message allows a first party to pass on a message to a second party without directly speaking to the second party. The overall process of leaving a voice message includes multiple steps. As an example, if a caller is calling a call receiver, the caller leaves a voice mail for the call receiver after a certain prompt from the call receiver. Usually, the prompt is a message which is set up by the call receiving party. When the message from the call receiver is played, the caller proceeds to leave a message for the call receiver.

A voicemail system is equally beneficial to the call receiver and also the caller. As an example, if the call receiver is unavailable at the time of the call, the call receiver can still receive the message from the caller through the voicemail system. Therefore, the call receiver can address the message of the caller at an available time. On the other hand, the caller is allowed to leave a message at his or her convenience. However, the existing voicemail systems can have certain drawbacks too.

The lack of uniqueness is one of the main drawbacks of the existing voicemail systems. As mentioned before, the voicemail functions such that a message is replayed to the caller when the user is unavailable. However, the replayed message is consistent for all callers. As an example, the voice message replayed for a family member is the same as the voicemail replayed to a coworker. Usually the replayed voice message contains information on whose line the caller has reached and when the user will be able to get back to the caller. Even though the existing voicemail systems serve the purpose of receiving and transferring a message, the existing voicemail systems lack personalization since the same voice message is replayed for all callers.

The objective of the present invention is to address the lack of personalization. In particular, the present invention allows the user to set personalized voice messages for preferred contacts. As a result, the voice message played to a first contact of the contact list is different from the voice message played to a second contact of the contact list. By following the method of the present invention, the user can personalize the message that prompts the caller to leave a voice mail.

### BRIEF DESCRIPTION OF THE DRAWINGS

FIG. 1 is a flowchart illustrating the basic overall process of the present invention.

FIG. 2A is a flowchart illustrating the basic overall process of receiving a voice message and a plurality of designated alert tones as the customized voicemail message.

FIG. 2B is a flowchart illustrating the basic overall process of receiving the voice message as the customized voicemail message.

FIG. 3 is a flowchart illustrating the basic overall process of receiving a video message as the customized voicemail message.

FIG. 4 is a flowchart illustrating the basic overall process of receiving the customized voicemail message for a group of contacts.

FIG. 5 is a flowchart illustrating the basic overall process of assigning a default voicemail message for the plurality of stored contact.

FIG. 6 is a flowchart illustrating the basic overall process of assigning a first voicemail message and a second voicemail message to the at least one selected contact.

### DETAIL DESCRIPTIONS OF THE INVENTION

All illustrations of the drawings are for the purpose of describing selected versions of the present invention and are not intended to limit the scope of the present invention.

The present invention introduces a method to customize the outgoing message of a voicemail system. By utilizing the present invention the user can assign different outgoing messages for different contacts saved on the contact list. When the method of the present invention is utilized, the outgoing voicemail message played to a first caller is different from the outgoing voicemail message played to a second caller. In other words, the user has the ability to customize the outgoing voicemail message according to different categories which can be, but is not limited to, family contacts, contacts of friends, and work related contacts.

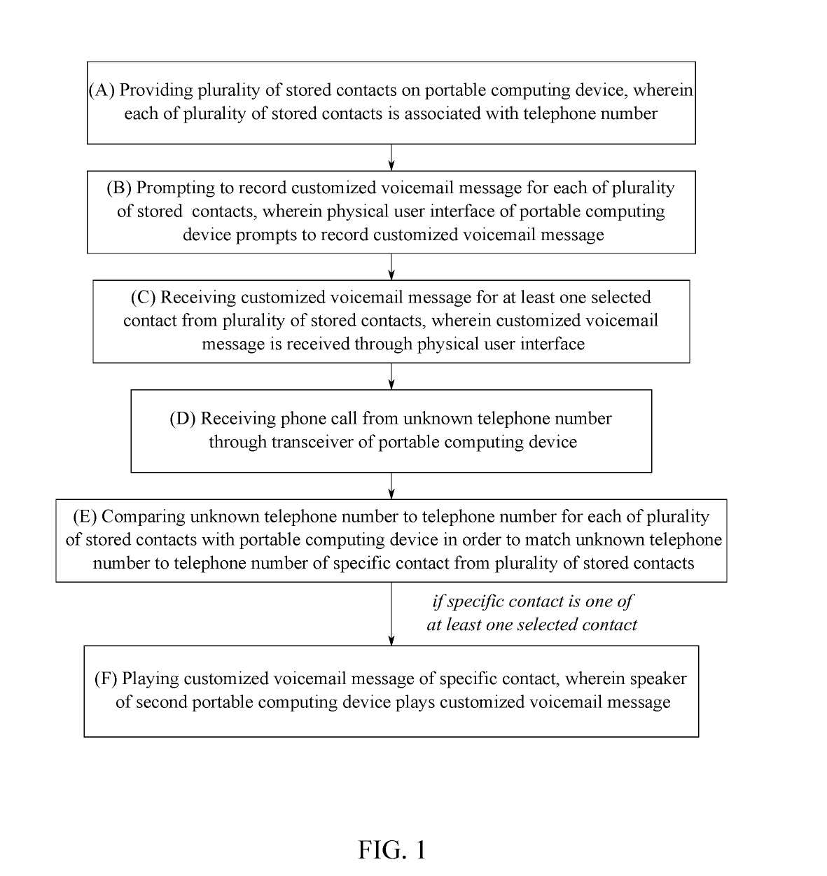

As illustrated in FIG. 1, in the process of providing a customized voicemail message, a plurality of stored contacts is initially provided. More specifically, the present invention utilizes the plurality of stored contacts on a portable computing device which can be, but is not limited to, a mobile phone. Each of the plurality of stored contacts is associated with a telephone number which differentiates one contact from the other contact. When the plurality of stored contacts is determined, the present invention prompts the user to record a customized voicemail message for each of the plurality of stored contacts. In doing so, a physical user interface of the portable computing device is used to prompt the user to record the customized voicemail message. The customized voicemail message can change according to user preference. As an example, if the customized voicemail message is for a family member or a friend, the customized voicemail can be informal in nature. However, if the customized voicemail is for a coworker or similar contact, the customized voicemail message can be comparatively formal in nature. When the user completes recording the customized voicemail message, the present invention receives the customized voicemail message for at least one selected contact from the plurality of stored contacts. The present invention utilizes the physical user interface to receive the customized voicemail message from the user. When the customized voicemail message is received from the user, the present invention assigns the customized voicemail message to the at least one selected contact.

When assigning the customized voicemail message is complete, the present invention ensures that the customized voicemail message is played when a call is received from the at least one selected contact. As a first step of this process, the present invention receives a phone call from an unknown telephone number through a transceiver of the portable computing device. When the phone call is received, the present invention compares the unknown telephone number to the telephone number for each of the plurality of stored contacts with the portable computing device in order to match the unknown telephone number to the telephone number of a specific contact from the plurality of stored contacts. After the comparison stage is complete, the customized voicemail message of the specific contact is played if the specific contact is one of the at least one selected contact. When the customized voicemail message is played, a speaker of a second portable computing device plays the customized voicemail message. In other words, the customized voicemail message is played through the speaker of a phone used by the caller.

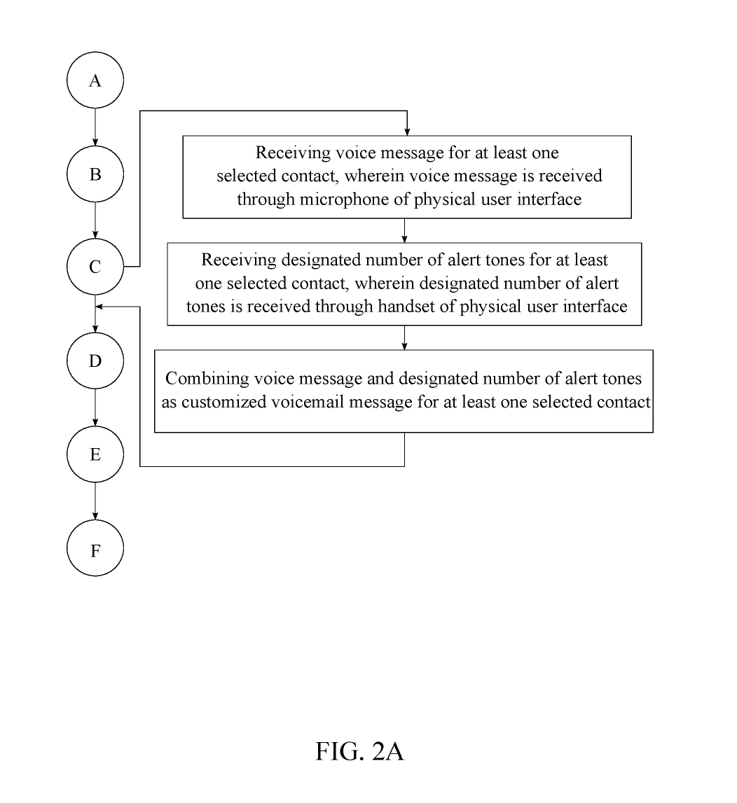

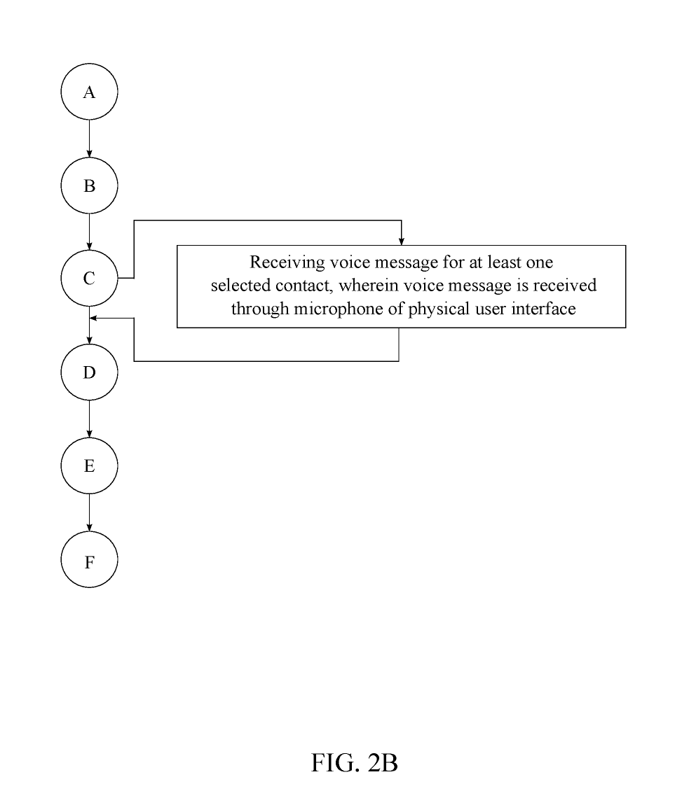

In the preferred embodiment of the present invention, the customized voicemail message contains a voice message. Similar to the traditional voice messages of existing voicemail systems, the voice message of the present invention can contain information such as user information and the best available time to call the user. Therefore, when the at least one selected contact calls the user, the at least one selected contact hears the voice message assigned to the at least one selected contact by the user. In the process of assigning the voice message as the customized voicemail message, the present invention receives the voice message for the at least one selected contact through a microphone of the physical user interface as seen in FIG. 2B. As an example, if the user is utilizing a mobile phone, the user speaks into the microphone of the mobile phone in order to provide the voice message. In addition to the voice message, the present invention allows the user to assign a designated number of alert tones to be played before the voice message is heard by the caller. As shown in FIG. 2A, in the process of assigning the designated number of alert tones, the present invention initially receives the designated number of alert tones for the at least one selected contact through a handset of the physical user interface. When the designated number of alert tones are received, the present invention combines the voice message with the number of designated number of alert tones as the customized voicemail message for the at least one selected contact. Therefore, when the user receives a telephone call from the at least one selected contact, the voice message is played only after the designated number of alert tones are exceeded. As an example, if the designated number of alert tones is three, the voice message assigned to the at least one selected contact is played to the caller after three alert tones are played.

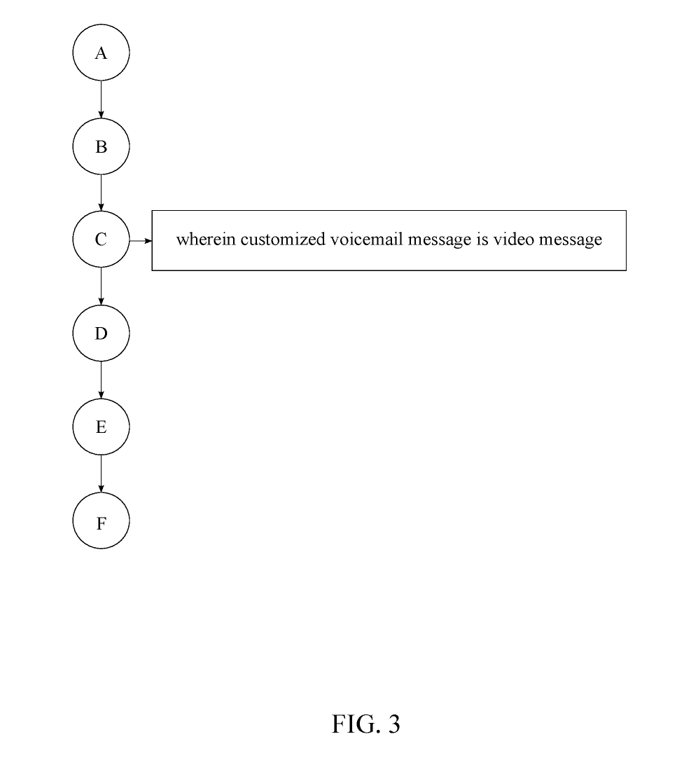

In contrast to using the voice message as the customized voicemail message, a video message can also be utilized as the customized voicemail message in another embodiment of the present invention. As illustrated in FIG. 3, when the video message is utilized, the present invention is executed in a similar manner. However, instead of hearing the voice message, the caller sees the video message which contains the voice message and other relevant visual information. The present invention utilizes a camera of the physical user interface to receive the video message from the user. The caller views the video message on a screen of the portable computing device. The video message can be used to provide more information to the caller or address the caller in a more personal manner.

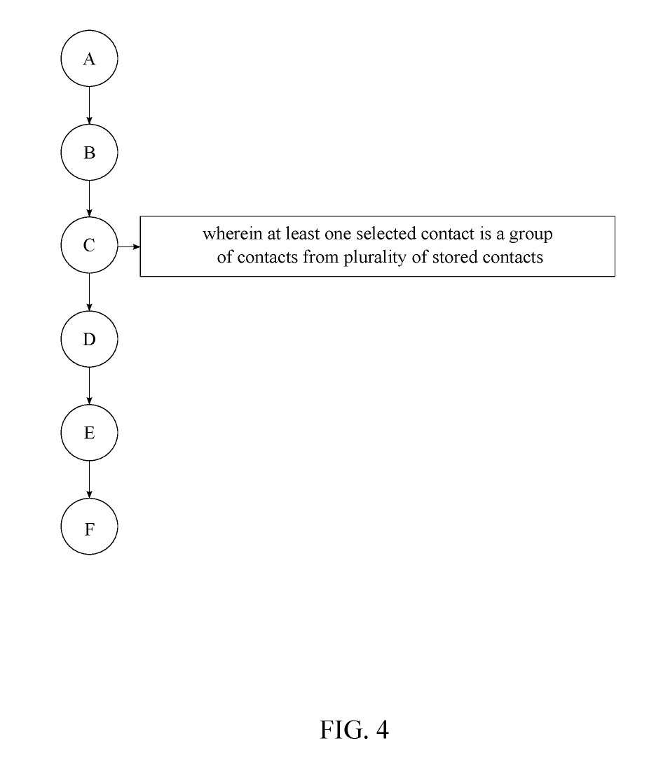

As previously discussed, the present invention receives the customized voicemail message for the at least one selected contact from the plurality of stored contacts. As seen in FIG. 4, a similar method is followed when the at least one selected contact is a group of contacts from the plurality of stored contacts. The group of contacts can be selected according to user preference. As an example, the group of contacts can be, but is not limited to, a group of family members or a group of friends. When the group of contacts is designated, the customized voicemail message which is unique to the group is played when any member of the group calls the user. As an example, we will consider receiving a call from a family member within the group of family members. When the call is received, the present invention identifies the family member as part of the group of family members and plays the customized voicemail message which is assigned to the group of family members.

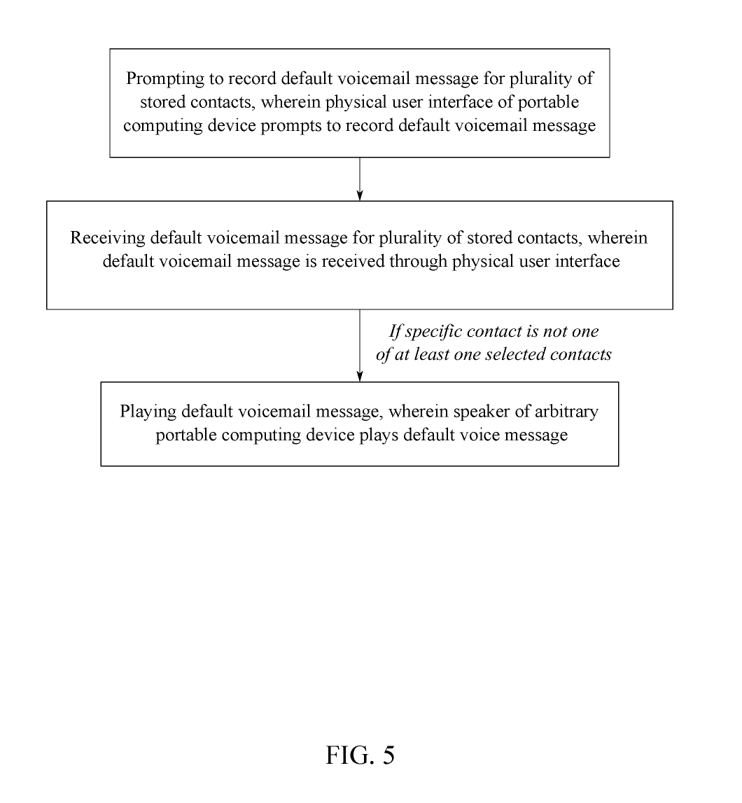

The present invention encourages assigning the customized voicemail message to each of the plurality of stored contacts. However, the present invention also allows the user to set a default voicemail message for each the plurality of stored contacts as illustrated in FIG. 5. Therefore, if the customized voicemail message is not assigned, the default voicemail message is utilized to receive a message from the caller or notify the caller regarding the unavailability of the user. In order to assign the default voicemail message, the present invention initially prompts the user to record the default voicemail message for the plurality of stored contacts through the physical user interface of the portable computing device. Next, the present invention receives the default voicemail message for the plurality of stored contacts through the physical user interface. Afterwards, similar to playing the customized voicemail message, the default voicemail message is played through the physical user interface. However, the default voice message is played only if the specific contact is not one of the at least one selected contact. The default voicemail message is played through a speaker of an arbitrary portable computing device. As an example, let us consider an instance wherein the user receives a telephone call from a telephone number which is not in the plurality of stored contacts. The present invention then identifies that the telephone number is unknown and proceeds to play the default voicemail message if the user is unavailable to attend the call.

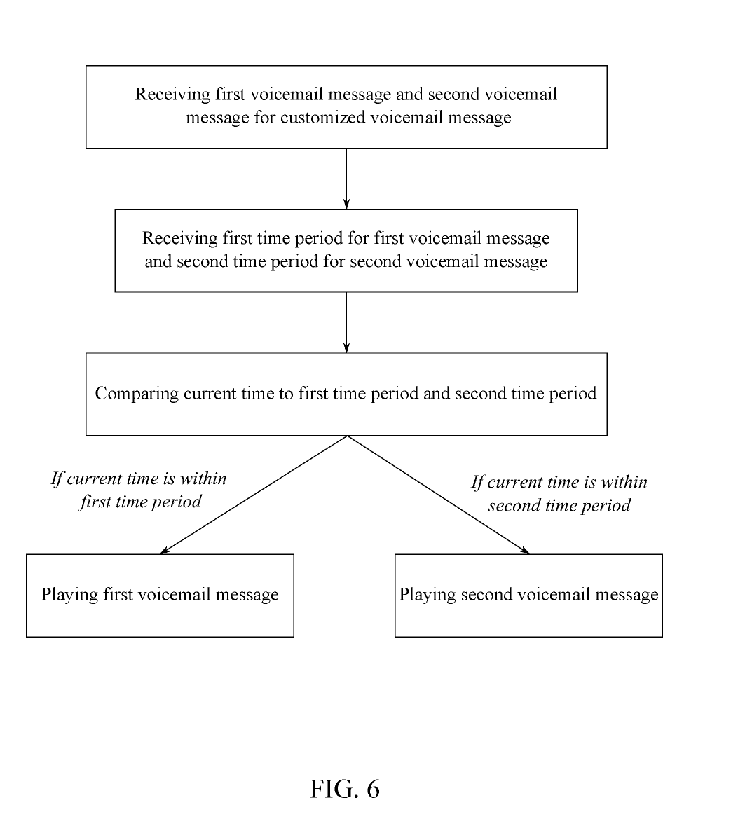

The present invention also allows the user to assign multiple voicemail messages for a contact. As illustrated in FIG. 6, the present invention receives a first voicemail message and a second voicemail message as the customized voicemail message. Next, the present invention receives a first time period for the first voicemail message and a second time period for the second voicemail message. When the specific contact is identified as one of the plurality of stored contacts, the present invention compares a current time (e.g. present hour/day) to the first time period and the second time period. Upon comparison, if the first time period is within the current time period, the first voicemail message is played. Likewise, if the current time is within the second time period, the second voicemail message is played. The first voicemail message and the second voicemail message are beneficial when the user intends on addressing a caller differently at different times. As an example, the first voicemail message can be a voicemail for a family member calling during a weekday. In contrast, the second voicemail message can be a voicemail for the family member calling during the weekend. The present invention can be beneficial to address contacts who speak different languages. As an example, if the at least one selected contact speaks Spanish, the customized voicemail message can be set in Spanish. On the other hand, the customized voicemail message for a remainder of the plurality of contacts can be set in English or any other preferred language. Even though Spanish and English are described in this example, the present invention can be used with a variety of other languages in other embodiments of the present invention.

When the present invention is being utilized, the following process flow can be followed. Initially, the present invention receives the customized voicemail message from the user. In order to provide the customized voicemail message, the user operates a user account or other comparable method. When the customized voicemail message is received, the customized voicemail is assigned to the at least one selected contact. Therefore, when the user receives a call from the telephone number associated with the at least one selected contact, the customized voicemail message is played. The caller hears the customized voicemail through the speaker of the second portable computing device. If the designated number of alert tones are assigned, the caller hears the customized voicemail message after the designated number of alert tones. If the at least one selected contact is not assigned with the customized voicemail message, the present invention plays the default voicemail message to the caller. If the video message is assigned to the at least one selected contact in another embodiment of the present invention, the video message is played to the caller. By utilizing the present invention, the user is assured to address the caller in a more personalized manner compared to the existing voicemail systems.

Although the invention has been explained in relation to its preferred embodiment, it is to be understood that many other possible modifications and variations can be made without departing from the spirit and scope of the invention as hereinafter claimed.

What is claimed is:

1. A method of storing personalized voice messages by executing computer-executable instructions stored on a non-transitory computer-readable medium, the method comprises the steps of:
providing a plurality of stored contacts on a portable computing device, wherein each of the plurality of stored contacts is associated with a telephone number;
prompting to record a customized voicemail message for each of the plurality of stored contacts, wherein a physical user interface of the portable computing device prompts to record the customized voicemail message;
receiving the customized voicemail message for at least one selected contact from the plurality of stored contacts, wherein the customized voicemail message is received through the physical user interface;
receiving a phone call from an unknown telephone number through a transceiver of the portable computing device;
comparing the unknown telephone number to the telephone number for each of the plurality of stored contacts with the portable computing device in order to match the unknown telephone number to the telephone number of a specific contact from the plurality of stored contacts; and
playing the customized voicemail message of the specific contact,
if the specific contact is one of the at least one selected contact,
wherein a speaker of a second portable computing device plays the customized voicemail message.

2. The method of storing personalized voice messages by executing computer-executable instructions stored on a non-transitory computer-readable medium, the method as claimed in claim 1 further comprises the steps of:
receiving a voice message for the at least one selected contact, wherein the voice message is received through a microphone of the physical user interface;
receiving a designated number of alert tones for the at least one selected contact, wherein the designated number of alert tones is received through a handset of the physical user interface; and
combining the voice message and the designated number of alert tones as the customized voicemail message for the at least one selected contact.

3. The method of storing personalized voice messages by executing computer-executable instructions stored on a non-transitory computer-readable medium, the method as claimed in claim 1 further comprises the steps of:
receiving a voice message for the at least one selected contact, wherein the voice message is received through a microphone of the physical user interface, wherein the customized voicemail message is the voice message.

4. The method of storing personalized voice messages by executing computer-executable instructions stored on a non-transitory computer-readable medium, the method as claimed in claim 1, wherein the customized voicemail message is a video message.

5. The method of storing personalized voice messages by executing computer-executable instructions stored on a non-transitory computer-readable medium, the method as claimed in claim 1, wherein the at least one selected contact is a group of contacts from the plurality of stored contacts.

6. The method of storing personalized voice messages by executing computer-executable instructions stored on a non-transitory computer-readable medium, the method as claimed in claim 1 further comprises the steps of:
prompting to record a default voicemail message for the plurality of stored contacts, wherein the physical user interface of the portable computing device prompts to record the default voicemail message;
receiving the default voicemail message for the plurality of stored contacts, wherein default voicemail message is received through the physical user interface; and
playing the default voicemail message,
if the specific contact is not one of the at least one selected contacts,
wherein a speaker of an arbitrary portable computing device plays the default voicemail message.

7. The method of storing personalized voice messages by executing computer-executable instructions stored on a non-transitory computer-readable medium, the method as claimed in claim 1 further comprises the steps of:
receiving a first voicemail message and a second voicemail message for the customized voicemail message;
receiving a first time period for the first voicemail message and a second time period for the second voicemail message;
comparing a current time to the first time period and the second time period;
playing the first voicemail message,
if the current time is within the first time period; and
playing the second voicemail message,
if the current time is within the second time period.
